(19) United States
(12) Patent Application Publication
(10) Pub. No.: US 2011/0080045 A1
(43) Pub. Date: Apr. 7, 2011

(54) SOLAR ENERGY SYSTEM FOR A BUILDING

(75) Inventor: Anthony C. Spikes, New York, NY (US)

(73) Assignee: Anthony C. Spikes, New York, NY (US)

(21) Appl. No.: 12/852,595

(22) Filed: Aug. 9, 2010

Related U.S. Application Data
(60) Provisional application No. 61/232,450, filed on Aug. 9, 2009.

(51) Int. Cl. H02J 1/00; F24J 2/00; H02J 7/00; H02J 3/00

(52) U.S. Cl. 307/38; 52/173.3; 320/101

(57) ABSTRACT

A solar energy system that maximizes the amount of a building surface space exposed to sunlight to capture the energy produce by the sun's rays. The solar paneling attached to the window frames, door frames and other natural architectural entry points of the building, electrical circuitry to link the solar energy system to the existing electrical system of the building and a battery station for storing energy generated by the solar energy system for use on demand at a later time.

### CROSS-REFERENCE TO RELATED APPLICATION

The present application claims priority from United States Provisional Application No. 61/232,450 filed on Aug. 9, 2009, the content of which is hereby incorporated by reference into this application.

### DESCRIPTION OF INVENTION

The invention is a new Solar Energy System that maximizes the amount of a building's surface space exposed to sunlight to capture the energy produced by the Sun's rays. The solar energy system of the present invention will be both standardized and customized.

Particularly the invention standardizes the application of solar energy generating systems by incorporating solar paneling attached to the window frames, door frames and other natural architectural entry points of existing buildings and electrical circuitry to link the solar energy system to the building's existing electrical system. The present invention is illustrated, for example, in FIG. 1.

For new building construction the invention incorporates the solar energy system into the initial architecture of the building to employ the maximum amount of surface space of the building to capture and harness solar energy yet maintain the architectural and aesthetic appeal of the building.

In both cases the solar energy system of the invention has a plug in feature that allows the captured solar energy to be fed directly into the building's electrical system to address immediate electricity use and demand or be redirected to a battery station to be stored for electricity demand at a later time as illustrated, for example in FIG. 2. FIG. 2 also shows other elements that may be included in the invention, such as, shunts, charge controllers, fuses or circuit breakers, auxiliary batteries chargers, meters, batteries, diverters, engine generators, etc. The solar energy system of the invention will increase electrical output of current solar systems in the range of 20%-200% for existing buildings and 100%-5000% or greater when incorporated in the design of new buildings.

The invention makes use of small and miniature solar panels that can be incorporated into the design and architecture of existing homes and commercial buildings to deliver both direct and indirect (stored) electrical current. As described in the Sustainability section, the present invention addresses the fact that current solar energy systems are very inefficient because they are most often roof mounted or completely detached and only harness a small amount of solar energy relative the amount of sunlight that bombards and showers the building. On any given day, the Sun's rays not only hit the roof top but shower 60%-100% of a building depending on location and design. The present invention could be used in conjunction with existing solar technology and design.

### BRIEF DESCRIPTION OF DRAWINGS

FIG. 1 shows an illustration of a typical home with a solar retention system;

FIG. 2 illustrates a feature that allows the captured solar energy to be fed directly into the building's electrical system to address immediate electricity use and demand or be redirected to a battery station to be stored for electricity demand at a later time.

### DETAILED DESCRIPTION OF THE DRAWINGS

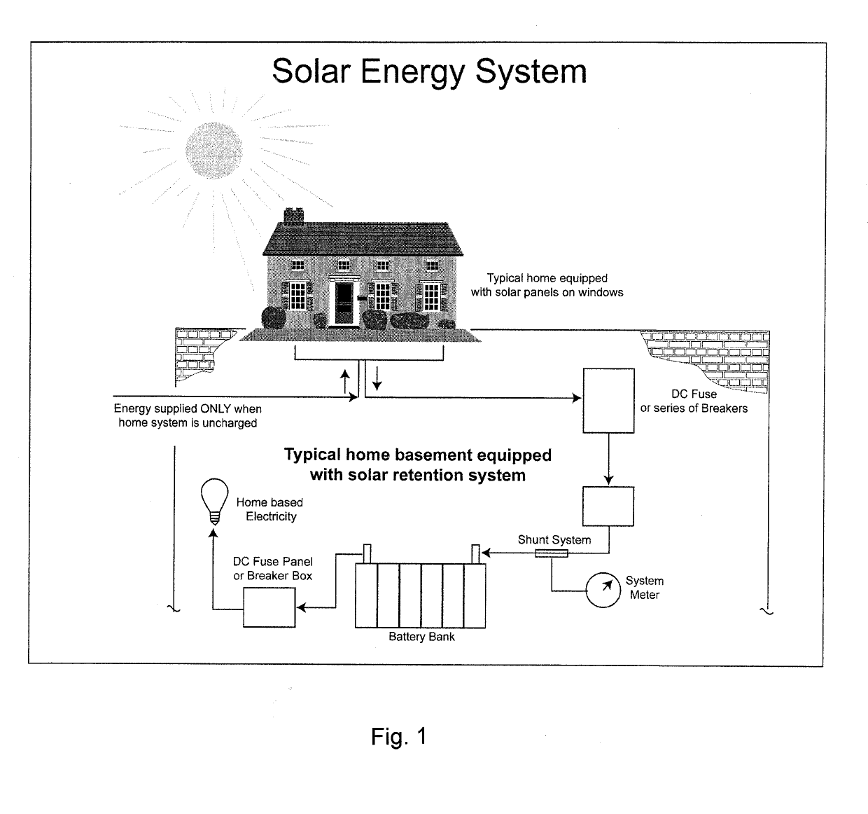

In FIG. 1, the solar energy generates a system by incorporating solar paneling attached to the window frames, door frames and other natural architectural entry points of existing buildings and electrical circuitry to link the solar energy system to the building's existing electrical system.

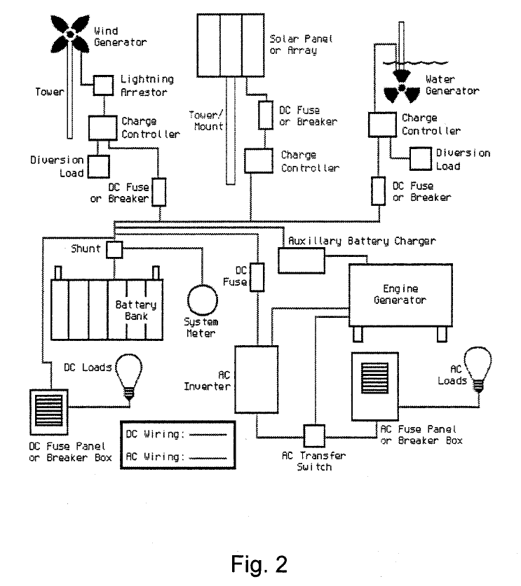

In FIG. 2, other elements such as shunts, charge controllers, fuses or circuit breakers, auxiliary batteries charges, meters, batteries, diverters, engine and generators will increase electrical output of current solar systems in the range of 20%-200% for existing buildings and 100%-5000% or greater when incorporated in the design of new buildings.

### Invention Category: Energy

Our invention category is Energy because we propose to reconfigure and increase the output of current solar energy systems.

### Sustainability Issue Addressed

The sustainability issued addressed is that the solar energy system of the present invention optimizes the amount of surface space of a building to capture sun rays and convert them into electricity. The solar energy system of the present invention can completely eliminate the “Grid” dependency of both existing and newly constructed buildings. As described in the Description of Invention section, current solar systems are mostly roof mounted or completely detached. As a result, the amount of surface space exposed to sunlight is not optimized and thus the energy output is not optimal. Our system on the other hand is compatible with current solar technology and can be used with current systems and technology to increase solar energy output. In addition, the solar energy system of the present invention not only applies to buildings but also applies to other structures that rely on electricity.

### How Does the Invention Relate to Buildings

The solar energy system of the present invention relates to buildings because it is designed to be incorporated into the building's structure to optimize the amount of the building's surface space to capture and convert solar energy to electricity. The standardized application of the present invention incorporates solar paneling into the window frames, door frames and other natural architectural entry points of existing buildings and electrical circuitry to link the solar energy system to the building's existing electrical system. For new building construction the solar energy system of the present invention is incorporated into the architecture of the building to employ the maximum amount of surface space of the building to capture and harness solar energy yet maintain the architectural and aesthetic appeal of the building.

### Conventional Systems

Conventional solar energy systems do not address the issue of maximizing a building's surface space to harness the most solar energy possible as in the present invention.

What is claimed is:

1. A solar energy system for use on a building comprising:
solar paneling attached to the window frames, door frames and other natural architectural entry points of the building; and
electrical circuitry to link the solar energy system to the existing electrical system of the building.

2. The solar energy system according to claim 1, further comprising:
a battery station for storing energy generated by the solar energy system for use on demand at a later time.

3. The solar energy system according to claim 2, further comprising:
a shunt that selectively directs energy generated by the solar energy system to the electrical circuitry to supply energy to the existing electrical system of the building or the battery station to store energy generated by the solar energy system for later use.
